(19) United States
(12) Patent Application Publication
(10) Pub. No.: US 2013/0052336 A1
(43) Pub. Date: Feb. 28, 2013

(54) METHOD OF MANUFACTURING LAMINATED BASE MATERIAL AND METHOD OF MANUFACTURING LIQUID CRYSTAL POLYESTER FILM

(71) Applicants: Ryo MIYAKOSHI, Tsukuba-shi (JP); Takeshi Kondo, Tsukuba-shi (JP)

(72) Inventors: Ryo MIYAKOSHI, Tsukuba-shi (JP); Takeshi Kondo, Tsukuba-shi (JP)

(73) Assignee: Sumitomo Chemical Company, Limited

(21) Appl. No.: 13/599,589

(22) Filed: Aug. 30, 2012

(30) Foreign Application Priority Data
Aug. 31, 2011 (JP) 2011-188220

(51) Int. Cl. B05D 5/12; B29C 71/02

(52) U.S. Cl. 427/58; 264/234

(57) ABSTRACT

A method of manufacturing a laminated base material having a conductive foil and an insulating layer formed on the conductive foil includes a drying process in which a liquid composition which includes a liquid crystal polyester, a solvent in which the liquid crystal polyester dissolves, and a heat-conducting filling material, and has a proportion of the content of the heat-conducting filling material in the sum of the content of the liquid crystal polyester and the content of the heat-conducting filling material of 30% to 80% by volume is coated on the conductive foil, heated to 120° C. to 220° C. so as to remove the solvent, thereby forming a coated film, and a thermal treatment process in which the coated film formed on the conductive foil is heated to a temperature that is the liquid crystal transition temperature of the liquid crystal polyester or higher so as to form an insulating layer.

Priority is claimed on Japanese Patent Application No. 2011-188220, filed on Aug. 31, 2011, the contents of which are incorporated herein by reference.

### BACKGROUND OF THE INVENTION

1. Field of the Invention

The present invention relates to a method of manufacturing a laminated base material and a method of manufacturing a liquid crystal polyester film.

2. Description of Related Art

In the past, electronic components, such as power transistors or hybrid ICs, became known. In such electronic components, a heat dissipation member having a high heat conductivity is used to dissipate driving heat emitted from the electronic components. As such a heat dissipation member, a variety of configurations, such as a base material in which an IC or the like is mounted and a separately provided heat conductive sheet for heat dissipation, are known.

Thus far, as the heat dissipation member for electronic components, members obtained by mixing aluminum oxide or boron nitride as a heat-conducting filling material into a film using a resin material, such as a silicone rubber or an epoxy resin have been proposed (for example, Patent Document 1).

Furthermore, in recent years, as the mounting density of the electronic components has been increasing, the amount of heat generation has increased. Therefore, there is a demand for a material having a higher heat conductivity as a material for forming a base material.

Due to the above technical background, studies are being made regarding use of a liquid crystal polyester having a higher heat conductivity than the silicone rubber or the epoxy resin as a material for the heat dissipation member. For example, in the metal-base circuit substrate described in Patent Document 1, an insulating layer is formed using a liquid crystal polyester as a resin component so that the heat conductivity improves compared to a configuration in which an insulating layer is formed using an epoxy resin.

### CITATION LIST

Patent Document
[Patent Document 1] Japanese Unexamined Patent Application, First Publication No. 2003-60134
[Patent Document 2] PCT International Publication No. WO10/117,023

### SUMMARY OF THE INVENTION

However, metal-base circuit substrates having the liquid crystal polyester insulating layer disclosed in Patent Documents described above has additional scope for improvement in terms of heat conductivity.

The invention has been made in consideration of the above circumstances, and an object of the invention is to provide a method of manufacturing a laminated base material having a high heat conductivity. In addition, another object of the invention is to provide a method of manufacturing a liquid crystal polyester film having a high heat conductivity.

In order to solve the above problems, the invention provides a method of manufacturing a laminated base material having a conductive foil and an insulating layer formed on the conductive foil, including: a drying process in which a liquid composition which includes a liquid crystal polyester, a solvent in which the liquid crystal polyester dissolves, and a heat-conducting filling material, and has a proportion of the content of the heat-conducting filling material in the sum of the content of the liquid crystal polyester and the content of the heat-conducting filling material of 30% by volume to 80% by volume is coated on the conductive foil, heated to 120° C. to 220° C. so as to remove the solvent, thereby forming a coated film; and a thermal treatment process in which the coated film formed on the conductive foil is heated to a temperature that is the liquid crystal transition temperature of the liquid crystal polyester or higher so as to form an insulating layer.

In the invention, in the thermal treatment process, the insulating layer is preferably formed by increasing the temperature of the coated film at a rate of 1.0° C./min to 200° C./min from a temperature of 0° C. to 220° C. to a temperature that is the liquid crystal transition temperature of the liquid crystal polyester or higher.

In the invention, the heat-conducting filling material preferably includes at least one inorganic powder selected from a group consisting of aluminum oxide, aluminum nitride, and boron nitride.

In the invention, the liquid crystal polyester is preferably a liquid crystal polyester having a repeating unit represented by the following formula (1), a repeating unit represented by the following formula (2), and a repeating unit represented by the following formula (3).

—O—Ar¹—CO— (1)

—CO—Ar²—CO— (2)

—X—Ar³—Y— (3)

In the formulas, Ar¹ represents a phenylene group, a naphthylene group, or a biphenylylene group; each of Ar² and Ar³ independently represent a phenylene group, a naphthylene group, a biphenylylene group, or a group represented by the following formula (4); each of X and Y independently represent an oxygen atom or an imino group; and each of hydrogen atoms in the groups represented by Ar¹, Ar², and Ar³ may be replaced by a halogen atom, an alkyl group, or an aryl group respectively.)

—Ar⁴—Z—Ar⁵— (4)

In the formula, Ar⁴ and Ar⁵ independently represent a phenylene group or a naphthylene group; and Z represents an oxygen atom, a sulfur atom, a carbonyl group, a sulfonyl group, or an alkylidene group.)

In the invention, the liquid crystal polyester preferably has 30 mol % to 80 mol % of the repeating unit represented by the formula (1), 10 mol % to 35 mol % of the repeating unit represented by the formula (2), and 10 mol % to 35 mol % of the repeating unit represented by the formula (3) with respect to the total amount of all the repeating units that compose the liquid crystal polyester.

In the invention, in the repeating unit represented by the formula (3), at least one of X and Y is preferably an imino group.

In addition, the method of manufacturing a liquid crystal polyester film of the invention includes: a drying process in which a liquid composition which includes the liquid crystal polyester, a solvent in which the liquid crystal polyester dissolves, and a heat-conducting filling material, and has a proportion of the content of the heat-conducting filling material in the sum of the content of the liquid crystal polyester and the content of the heat-conducting filling material of 30% by volume to 80% by volume is coated on a supporting base material, heated to 120° C. to 220° C. so as to remove the solvent, thereby forming a coated film; a thermal treatment process in which the coated film formed on the supporting base material is heated to a temperature that is the liquid crystal transition temperature of the liquid crystal polyester or higher; and a filming process in which the supporting base material is removed so as to obtain a liquid crystal polyester film.

According to the invention, it is possible to provide a method of manufacturing a laminated base material having a high heat conductivity.

In addition, it is possible to provide a method of manufacturing a liquid crystal polyester film having a high heat conductivity.

### DETAILED DESCRIPTION OF THE INVENTION

Hereinafter, a method of manufacturing a laminated base material and a method of manufacturing a liquid crystal polyester film according to embodiments of the invention will be described.

The laminated base material of the embodiment has a conductive foil and an insulating layer formed on the conductive foil. The insulating layer includes a liquid crystal polyester and a heat-conducting filling material, and the proportion ([B/(A+B)]×100) of the content of the heat-conducting filling material in the sum (A+B) of the content (volume A) of the liquid crystal polyester and the content (volume B) of the heat-conducting filling material in the insulating layer is 30% by volume to 80% by volume. The conductive foil may be patterned as necessary.

In addition, the liquid crystal polyester film of the embodiment is, for example, a film obtained by removing the conductive foil from the laminated base material. Meanwhile, the liquid crystal polyester film of the embodiment can also be obtained by laminating layers having the same configuration as that of the insulating layer on a variety of supporting base materials and then removing the supporting base materials, in addition to by laminating layers on the conductive foil.

Liquid Crystal Polyester

A liquid crystal polyester used in the embodiment is a liquid crystal polyester showing liquid crystallinity in a molten state, and preferably melts at a temperature of 220° C. to 450° C. Meanwhile, the liquid crystal polyester may be a liquid crystal polyester amide, a liquid crystal polyester ether, a liquid crystal polyester carbonate, or a liquid crystal polyester imide. The liquid crystal polyester is preferably a wholly aromatic polyester formed using an aromatic compound alone as a raw material monomer.

In the present specification, the “liquid crystal polyester amide” refers to a polymer having a plurality of ester groups and amide groups, and exhibiting liquid crystal properties with forming a line of the molecule in a molten state.

In the specification, the “liquid crystal polyester ether” refers to a polymer having a plurality of ester groups and ether groups, and exhibiting liquid crystal properties with forming a line of the molecule in a molten state.

In the specification, the “liquid crystal polyester carbonate” refers to a polymer having a plurality of ester groups and carbonate groups, and exhibiting liquid crystal properties with forming a line of the molecule in a molten state.

In the specification, the “liquid crystal polyester imide” refers to a polymer having a plurality of ester groups and imide groups, and exhibiting liquid crystal properties with forming a line of the molecule in a molten state.

In the specification, the “aromatic compound” refers to a cyclic unsaturated organic compound having a polymerizable substituent. The cyclic unsaturated organic compound may be an aromatic hydrocarbon composed of hydrocarbon alone, or a heterocyclic aromatic compound including atoms other than carbon in the ring structure. Examples of the polymerizable substituent include a hydroxyl group, a carboxylic group, an amino group, an isocyanate group, and the like.

Typical examples of the liquid crystal polyester include polyesters formed through polymerization (that is, condensation polymerization) of at least one compound selected from a group consisting of aromatic hydroxycarboxylic acids, aromatic dicarboxylic acids, aromatic diols, aromatic hydroxylamines, and aromatic diamines; polyesters formed through polymerization of plural kinds of aromatic hydroxycarboxylic acids; polyesters formed through polymerization of at least one compound selected from a group consisting of aromatic dicarboxylic acids, aromatic diols, aromatic hydroxyamines, and aromatic diamines; and polyesters formed through polymerization of a polyester, such as polyethylene terephthalate, and an aromatic hydroxycarboxylic acid. Here, as the aromatic hydroxycarboxylic acid, the aromatic dicarboxylic acids, the aromatic diols, the aromatic hydroxylamines, and the aromatic diamines, polymerizable derivatives thereof may be used instead of part or all of the above respectively.

In the specification, the “aromatic hydroxycarboxylic acid” refers to an aromatic compound having a hydroxyl group and a carboxylic group. Specific examples thereof include structural units derived from p-hydroxybenzoic acid, 2-hydroxy-6-naphthoic acid 4-hydroxy-4′-biphenylcarboxylic acid.

In the specification, the “aromatic dicarboxylic acid” refers to an aromatic compound having two or more hydroxyl groups. Specific examples thereof include structural units derived from terephthalic acid, isophthalic acid and 2,6-naphthalenedicarboxylic acid.

In the specification, the “aromatic diol” refers to an aromatic compound having two or more hydroxyl groups. Specific examples thereof include structural units derived from hydroquinone, resorcinol and 4,4′-dihydroxydiphenyl.

In the specification, the “aromatic hydroxyamine” refers to an aromatic compound having a hydroxyl group and an amino group. Specific examples thereof include structural units derived from 3-aminophenol and 4-aminophenol.

In the specification, the “aromatic diamine” refers to an aromatic compound having two or more amino groups. Specific examples thereof include structural units derived from 1,4-phenylenediamine and 1,3-phenylenediamine.

Examples of the polymerizable derivative in the compound having a carboxylic group, such as the aromatic hydroxycarboxylic acid or the aromatic dicarboxylic acid include derivatives in which a carboxylic group had been converted to an alkoxy carbonyl group or an aryloxy carbonyl group (that is, an ester group); derivatives in which a carboxylic group had been converted to a haloformyl group (that is, an acid halide); and derivatives in which a carboxylic group had been converted to an acyloxy carbonyl group (that is, an acid anhydride). Examples of the polymerizable derivative in the compound having a hydroxyl group, such as the aromatic hydroxycarboxylic acid, the aromatic diol, and the aromatic hydroxylamine include derivatives formed by acylating a hydroxyl group to an acyloxyl group (that is, an acrylate derivatives). Examples of the polymerizable derivative in the compound having an amino group, such as the aromatic hydroxylamine and the aromatic diamine include derivatives (that is, acylate derivatives) in which an amino group had been acylated to form an acylamino group.

The liquid crystal polyester preferably has a repeating unit represented by the following formula (1) (hereinafter sometimes referred to as the “repeating unit (1)”), and more preferably has the repeating unit (1), a repeating unit represented by the following formula (2) (hereinafter sometimes referred to as the “repeating unit (2)”), and a repeating unit represented by the following formula (3) (hereinafter sometimes referred to as the “repeating unit (3)”).

—O—Ar¹—CO— (1)

—CO—Ar²—CO— (2)

—X—Ar³—Y— (3)

In the formulas, Ar¹ represents a phenylene group, a naphthylene group, or a biphenylylene group; each of Ar² and Ar³ independently represent a phenylene group, a naphthylene group, a biphenylylene group, or a group represented by the following formula (4); each of X and Y independently represent an oxygen atom or an imino group (—NH—); each of hydrogen atoms in the groups represented by Ar¹, Ar², and Ar³ may be replaced by a halogen atom, an alkyl group, or an aryl group.

—Ar⁴—Z—Ar⁵— (4)

In the formula, Ar⁴ and Ar⁵ independently represent a phenylene group or a naphthylene group; and Z represents an oxygen atom, a sulfur atom, a carbonyl group, a sulfonyl group, or an alkylidene group.)

Examples of the halogen atom include a fluorine atom, a chlorine atom, a bromine atom, and an iodine atom.

The alkyl group preferably has 1 to 10 carbon atoms.

Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group.

The aryl group preferably has 6 to 20 carbon atoms.

Examples of the aryl group include a phenyl group, an o-tolyl group, an m-tolyl group, a p-tolyl group, a 1-naphthyl group, and a 2-naphthyl group.

In a case in which the hydrogen atom is replaced by the above group, the number of the substituted atoms is preferably 1 to 2, and more preferably 1 for each of the above groups represented by Ar¹, Ar², and Ar³.

The alkylidene group preferably has 1 to 10 carbon atoms.

Examples of the alkylidene group include a methylene group, an ethylene group, an isopropylidene group, an n-butylidene group, and a 2-ethylhexylidene group.

The repeating unit (1) is a repeating unit derived from a predetermined aromatic hydroxycarboxylic acid. The repeating unit (1) is preferably a repeating unit in which Ar¹ is a p-phenylene group (that is, a repeating unit derived from p-hydroxybenzoic acid) or a repeating unit in which Ar¹ is a 2,6-naphthylene group (that is, a repeating unit derived from 6-hydroxy-2-naphthoic acid).

The repeating unit (2) is a repeating unit derived from a predetermined aromatic dicarboxylic acid. The repeating unit (2) is preferably a repeating unit in which Ar² is a p-phenylene group (that is, a repeating unit derived from terephthalic acid), a repeating unit in which Ar² is a m-phenylene group (that is, a repeating unit derived from isophthalic acid), a repeating unit in which Ar² is a 2,6-naphthylene group (that is, a repeating unit derived from 2,6-naphthylene dicarboxylic acid), or a repeating unit in which Ar² is a diphenyl ether-4,4′-diyl group (that is, a repeating unit derived from diphenyl ether-4,4′-dicarboxylic acid).

The repeating unit (3) is a repeating unit derived from a predetermined aromatic diol, aromatic hydroxylamine, or aromatic diamine. The repeating unit (3) is preferably a repeating unit in which Ar³ is a p-phenylene group (that is, a repeating unit derived from hydroquinone, p-aminophenol, or p-phenylenediamine) or a repeating unit in which Ar³ is a 4,4′-biphenylylene group (that is, a repeating unit derived from 4,4′-dihydroxybiphenyl, 4-amino-4′-hydroxybiphenyl, or 4,4′-diaminobiphenyl).

More specifically, a combination of the repeating unit (1) in which Ar¹ is a 2,6-naphthylene group in the formula (1), the repeating unit (2) in which Ar² is an m-phenylene group in the formula (2), the repeating unit (3) in which Ar³ is a p-phenylene group, X is a hydroxy group, and Y is an amino group in the formula (3) is preferable.

The content of the repeating unit (1) is preferably 30 mol % or more, more preferably 30 mol % to 80 mol %, still more preferably 30 mol % to 60 mol %, and particularly preferably 30 mol % to 40 mol % with respect to the content of all the repeating units (a value obtained by computing the equivalent amounts (moles) of the respective units by dividing the masses of the respective repeating units that compose the liquid crystal polyester by the formula weights of the respective repeating units, and then summing the equivalent amounts).

Similarly, the content of the repeating unit (2) is preferably 35 mol % or less, more preferably 10 mol % to 35 mol %, still more preferably 20 mol % to 35 mol %, and particularly preferably 30 mol % to 35 mol % with respect to the content of all the repeating units.

Similarly, the content of the repeating unit (3) is preferably 35 mol % or less, more preferably 10 mol % to 35 mol %, still more preferably 20 mol % to 35 mol %, and particularly preferably 30 mol % to 35 mol % with respect to the content of all the repeating units.

The reason why the content of the repeating unit (1) is limited as above is that, as the content of the repeating unit (1) increases, heat resistance, strength, and stiffness are liable to improve; however, if the content increases excessively, solubility in a solvent is liable to degrade.

The proportion of the content of the repeating unit (2) in the content of the repeating unit (3) is expressed by [the content of the repeating unit (2)]/[the content of the repeating unit (3)] (mol/mol), preferably 0.9/1 to 1/0.9, more preferably 0.95/1 to 1/0.95, and still more preferably 0.98/1 to 1/0.98.

Meanwhile, the liquid crystal polyester may contain two or more kinds of the repeating units (1) to (3) respectively. In addition, the liquid crystal polyester may have repeating units other than the repeating units (1) to (3), and the content thereof is preferably 0 mol % to 10 mol %, and more preferably 0 mol % to 5 mol % with respect to the content of all the repeating units.

The liquid crystal polyester preferably has the repeating unit (3) in which at least one of X and Y is an imino group, that is, has one or both of a repeating unit derived from a predetermined aromatic hydroxylamine and a repeating unit derived from an aromatic diamine since solubility in a solvent is excellent. The liquid crystal polyester more preferably has only the repeating unit (3) in which at least one of X and Y is an imino group.

The liquid crystal polyester is preferably manufactured through melting and polymerization of raw material monomers corresponding to the repeating groups that compose the liquid crystal polyester, and then solid-phase polymerization of the obtained polymerized product (that is, prepolymer). Thereby, it is possible to manufacture a high-molecular-weight liquid crystal polyester having high heat resistance, strength, and stiffness with favorable operability. The melting and polymerization may be carried out in the presence of a catalyst, and examples of the catalyst include metallic compounds, such as magnesium acetate, stannous acetate, tetrabutyl titanate, lead acetate, sodium acetate, potassium acetate, and stibium trioxide; and nitrogen-containing heterocyclic compounds, such as 4-(dimethylamino)pyridine, and 1-methylimidazole. Among the above, the nitrogen-containing heterocyclic compounds are preferably used. Among the nitrogen-containing heterocyclic compounds, 1-methylimidazole is preferable.

The temperature of the melting and polymerization is preferably 130° C. to 400° C.

The time of the melting and polymerization is preferably 1 hours to 30 hours.

The solid-phase polymerization is preferably carried out under an inert gas atmosphere such as nitrogen gas.

The temperature of the solid-phase polymerization is preferably 200° C. to 350° C.

The time of the solid-phase polymerization is preferably 1 hour to 30 hours.

The liquid crystal polyester used as a raw material in the method of manufacturing a laminated base material and the method of manufacturing a liquid crystal polyester film of the embodiment has a flow initiation temperature of preferably 260° C. or lower, more preferably 120° C. to 260° C., still more preferably 150° C. to 250° C., and particularly preferably 150° C. to 220° C. As the flow initiation temperature of the liquid crystal polyester decreases, there is a tendency of the heat conductivity in the thickness direction of an insulating layer in a laminated base material obtained through a thermal treatment or the liquid crystal polyester film improving. However, when the flow initiation temperature is too low, the heat resistance, strength, and stiffness of the insulating layer are liable to become insufficient even after a thermal treatment.

Meanwhile, the flow initiation temperature is also termed a flow temperature or a flow temperature, is a temperature at which the viscosity reaches 4800 Pa·s (4800 poise) when the liquid crystal polyester is melted and extracted through a nozzle having an inner diameter of 1 mm and a length of 10 mm while increasing the temperature at a rate of 4° C./min under a load of 9.8 MPa (100 kg/cm²) using a capillary rheometer, and serves as a standard for the molecular weight of the liquid crystal polyester (refer to “Liquid Crystal Polymers—Synthesis, Formation, and Applications—,” Naoyuki Koide, CMC Publishing Co., Ltd., Jun. 5, 1987, p. 95).

(Solvent)

A liquid-phase composition is obtained by dissolving or dispersing the liquid crystal polyester in a solvent, preferably by dissolving in a solvent. As the solvent, a solvent in which the liquid crystal polyester being used can be dissolved or dispersed, specifically, a solvent in which the liquid crystal polyester can be dissolved at 50° C. at a concentration of 1 weight % to 50 weight % ([the weight of the liquid crystal polyester]/[the weight of the liquid crystal polyester+the weight of the solvent]) is appropriately selected and used.

Examples of the solvent include halogenated hydrocarbons, such as dichloromethane, chloroform, 1,2-dichloroethane, 1,1,2,2-tetrachloroethane, and o-dichlorobenzene; halogenated phenols, such as p-chlorophenol, pentachlorophenol, and pentafluorophenol; ethers, such as diethyl ether, tetrahydrofuran, and 1,4-dioxane; ketones, such as acetone and cyclohexanone; esters, such as ethyl acetate and γ-butyrolactone; carbonates, such as ethylene carbonate and propylene carbonate; amines, such as triethylamine; nitrogen-containing heterocyclic aromatic compounds, such as pyridine; nitriles, such as acetonitrile and succinonitrile; amide-based solvents (that is, organic solvents having an amide bond), such as N,N-dimethylformamide, N,N-dimethylacetamide, and N-methylpyrrolidone; urea compounds, such as tetramethylurea; nitro compounds, such as nitromethane and nitrobenzene; sulfur compounds, such as dimethylsulfoxide and sulfolane; phosphorous compounds, such as hexamethylphosphateamide and tri-n-butylphosphate. In addition, two or more solvents may be used in combination.

The solvent is preferably a solvent mainly including an aprotic compound, particularly, an aprotic compound having no halogen atom due to having low corrosion properties and easy handling. Specific examples of the solvent mainly including an aprotic compound having no halogen atom include amide-based solvents (that is, organic solvents having an amide bond), such as N,N-dimethylformamide, N,N-dimethylacetamide, and N-methylpyrrolidone. The proportion of the aprotic compound in the entire solvent is preferably 50 weight % to 100 weight %, more preferably 70 weight % to 100 weight %, and still more preferably 90 weight % to 100 weight %. In addition, as the aprotic compound, an amide-based solvent having no halogen atom is preferably used. Among amide-based solvents, an amide-based solvent, such as N,N-dimethylformamide, N,N-dimethylacetamide, or N-methylpyrrolidone, is preferably used due to easy dissolution of the liquid crystal polyester.

In addition, the solvent is preferably a solvent mainly including a compound having 3 to 5 dipolar moments due to easy dissolution of the liquid crystal polyester. The proportion of the compound having 3 to 5 dipolar moments in the entire solvent is preferably 50 weight % to 100 weight %, more preferably 70 weight % to 100 weight %, and still more preferably 90 weight % to 100 weight %. In the invention, the aprotic compound having 3 to 5 dipolar moments is particularly preferably used as the solvent. Specific examples of the aprotic compound having 3 to 5 dipolar moments include N,N-dimethylformamide, N,N-dimethylacetamide, and N-methylpyrrolidone.

In addition, as the solvent, a solvent mainly including a compound having a boiling point of 100° C. to 220° C. at 1 atmosphere is preferable due to easy removal, the proportion of the compound having a boiling point of 100° C. to 220° C. at 1 atmosphere in the entire solvent is preferably 50 weight % to 100 weight %, more preferably 70 weight % to 100 weight %, and still more preferably 90 weight % to 100 weight %, and a compound having a boiling point of 100° C. to 220° C. at 1 atmosphere is preferably used as the aprotic compound.

Specific example of the compound having a boiling point of 100° C. to 220° C. at 1 atmosphere include N,N-dimethylformamide, N,N-dimethylacetamide, and N-methylpyrrolidone.

The content of the liquid crystal polyester in the liquid-phase composition is preferably 5 weight % to 60 weight %, more preferably 10 weight % to 50 weight %, and still more preferably 15 weight % to 45 weight % with respect to the total amount of the liquid crystal polyester and the solvent. The content of the liquid crystal polyester in the liquid-phase composition is appropriately adjusted so as to obtain a liquid-phase composition having a desired viscosity, and obtain a film having a desired thickness.

(Heat-Conducting Filling Material)

In the embodiment, a heat-conducting filling material is added to and dispersed in the liquid-phase composition for the purpose of making the heat-conducting filling material be contained in the insulating layer in the laminated base material or the liquid crystal polyester film. The particle diameter of the heat-conducting filling material is preferably 0.1 μm to 50 μm, and more preferably 1 μm to 10 μm.

Meanwhile, in the specification, the “heat-conducting filling material” refers to an additive being added for the purpose of increasing the heat conductivity of the liquid crystal polyester which is a mother material, and has a heat conductivity thereof is higher than that of a liquid crystal polyester being used.

That is, as the heat-conducting filling material, a material having a heat conductivity of usually 10 W/(m·K) to 500 W/(m·K), and preferably 30 W/(m·K) to 200 W/(m·K) is used, and, for example, one or two or more compounds selected from metallic oxides, metallic nitrides, and metallic carbides can be used. The heat-conducting filling material is preferably selected from oxides, nitrides, and carbides of elements in the first to seventh rows of groups II, III, and IV respectively in the periodic table.

Specific examples that can be used include one or more kinds of inorganic substances selected from a group consisting of beryllium oxide, magnesium oxide, aluminum oxide, thorium oxide, zinc oxide, silicon nitride, boron nitride, aluminum nitride, silicon carbide, silica, titanium oxide, zirconia, kaolin, calcium carbonate, and calcium phosphate. The compound is preferably used in a powder form, and the particle diameter is preferably 0.1 to 50 μm and more preferably 1 to 10 μm. Among the above, the heat-conducting filling material preferably includes powder of one or more kinds of inorganic substances selected from a group consisting of aluminum oxide, aluminum nitride, and boron nitride.

The heat-conducting filling material is included in the insulating layer of the laminated base material or the liquid crystal polyester film according to the invention so that the proportion of the content of the heat-conducting filling material in the sum (A+B) of the content (volume A) of the liquid crystal polyester and the content (volume B) of the heat-conducting filling material, that is, the value represented by a formula [B/(A+B)]×100 becomes 30% by volume to 80% by volume. Meanwhile, during manufacturing of the laminated base material and the liquid crystal polyester film of the embodiment, it is possible to control the content of the volume A and the volume B so as to obtain the above value by weighing the liquid crystal polyester and the heat-conducting filling material being used in amounts calculated by conversion from the densities thereof, and mixing them.

When the value represented by the formula [B/(A+B)]×100 is less than 30% by volume, the amount of the heat-conducting filling material is small, and therefore the heat conductivity of the laminated base material having the obtained insulating layer or the liquid crystal polyester film becomes insufficient, and it is difficult to obtain sufficient heat-releasing properties. In addition, when the value represented by the formula [B/(A+B)]×100 exceeds 80% by volume, the adhesion force between the insulating layer and the conductive foil is liable to be lacking during manufacturing of the laminated base material, and the reliability of the laminated base material degrades. In addition, during manufacturing of the liquid crystalline polyester film, the adhesion force between the liquid crystal polyester film and the supporting base material is liable to be lacking during manufacturing, and the manufacturing is liable to become difficult.

In a case in which the content of the heat-conducting filling material is in the above range, it is possible to supply a desired heat conductivity to the insulating layer of the laminated base material or the liquid crystal polyester film according to the invention. On the other hand, in a case in which the content of the heat-conducting filling material is in the above range, as described below, pores generated when the solvent is evaporated are liable to remain in the insulating layer, which causes degradation of heat conductivity. Therefore, in the embodiment, degradation of the heat conductivity of the insulating layer in the laminated base material or the liquid crystal polyester film is suppressed by preferably controlling the temperature condition during manufacturing even in a case in which a large amount of the heat-conducting filling material is blended.

(Other Components)

In addition, the insulating layer in the laminated base material or the liquid crystal polyester film according to the invention may contain well-known filling materials, additives, and the like other than the heat-conducting filling material as long as the object of the invention is not impaired. They are included in the insulating layer in the laminated base material or the liquid crystal polyester film according to the invention by adding and dispersing the liquid-phase composition, and employing the manufacturing method described below.

Examples of other filling materials include organic fillers, such as epoxy resin powder, melamine resin powder, urea resin powder, benzoguanamine resin powder, and a styrene resin.

Examples of additives include well-known coupling agents, antisettling agents, ultraviolet absorbents, heat stabilizers, and the like.

In addition, the liquid crystal polyester may include one or two or more elastomers, such as polypropylene, polyamide, polyester, polyphenylene sulfide, polyether ketone, polycarbonate, polyether sulfone, polyphenyl ether, and denatures thereof; thermoplastic resins, such as polyether imide; and copolymers of glycidyl methacrylate and polyethylene as long as the object of the invention is not impaired.

(Method of Manufacturing the Laminated Base Material and the Liquid Crystal Polyester Film)

A target laminated base material or liquid crystal polyester film is manufactured by coating the liquid-phase composition obtained in the above manner on the supporting base material, then, removing the solvent from the liquid-phase composition, and carrying out a thermal treatment on the obtained film.

More specifically, the liquid-phase composition is coated on a supporting base material, such as a conductive foil, heated to 120° C. to 220° C. so as to remove the solvent, thereby forming a coated film (drying process), and the coated film formed on the conductive foil is heated to a temperature that is the liquid crystal transition temperature of the liquid crystal polyester which is a raw material or higher so as to form an insulating layer (thermal treatment process), whereby a target laminated base material can be manufactured.

In addition, the liquid-phase composition is coated on a supporting base material, such as the conductive foil, heated to 120° C. to 220° C. so as to remove the solvent, thereby forming a coated film (drying process), the coated film formed on the conductive foil is heated to a temperature that is the liquid crystal transition temperature of the liquid crystal polyester which is a raw material or higher (thermal treatment process), and the supporting base material is removed so as to obtain a liquid crystal polyester film (filming process), whereby a target laminated base material can be manufactured.

As the method of manufacturing the laminated base material, specifically, when a conductive foil having conductivity, such as a metallic foil, is used as the supporting base material, a target laminated base material having an insulating layer of the liquid crystal polyester including a heat-conducting filling material formed on the surface of the conductive foil can be obtained.

In the specification, the “conductive foil” refers to a metal molded into a thin and flat shape. Specific examples of the conductive foil include a copper foil, an aluminum foil and a stainless steel foil.

In addition, as the method of manufacturing the liquid crystal polyester film, similarly to the laminated base material, a target liquid crystal polyester film including a heat-conducting filling material can be obtained by forming a liquid crystal polyester including a heat-conducting filling material in a film form on the surface of a supporting base material, and then removing the supporting base material.

Examples of the supporting base material for manufacturing the liquid crystal polyester film that can be used include materials having a variety of forms, such as sheet-shape members, such as glass sheets, resin sheets, and metal sheets; and film-shape members, such as resin films and metallic foils.

In addition, examples of the method of coating the liquid-phase composition on the supporting base material for both the method of manufacturing a laminated base material and the method of manufacturing a liquid crystal polyester film include a roller coating method, a deep coating method, a spray coating method, a spinner coating method, a curtain coating method, a slot coating method, and a screen printing method.

(Drying Process)

Evaporation of the solvent is preferable for removing the solvent since the operation is simple, and examples of methods therefor include heating, depressurization, and ventilation, and may be a combination thereof. Among the above, evaporation by heating is preferable, and evaporation by heating during ventilation is more preferable in terms of productivity or operability. The solvent is removed at a temperature of preferably 120° C. to 220° C., more preferably 120° C. to 200° C., and still more preferably 140° C. to 180° C. In addition, the solvent is removed for a time of 0.2 hours to 3 hours. Meanwhile, herein, the solvent does not need to be completely removed, and the residual solvent may be removed in the subsequent thermal treatment. That is, from the solvent included in the liquid-phase composition, 50 weight % to 100 weight % is preferably removed.

When the solvent is removed at a temperature lower than 120° C., the fluidity of the liquid crystal polyester is low during removal of the solvent, air bubbles generated when the solvent is volatilized are liable to remain in the coated film in the form of pores. The presence of such pores significantly degrades the heat conductivity of the obtained insulating layer in the laminated base material or the liquid crystal polyester film according to the invention. In addition, when pores are present, the insulating properties of the obtained insulating layer in the laminated base material or the liquid crystal polyester film according to the invention are liable to degrade.

Here, the “coated film” refers to an insulating layer to be dried.

In addition, when the solvent is removed at a temperature higher than 220° C., the molecular weight of the liquid crystal polyester used as a raw material increases during operation for solvent removal, and fluidity degrades, and therefore air bubbles generated when the solvent is volatilized are liable to remain in the coated film in the form of pores.

Meanwhile, the solvent removal temperature is preferably set to lower than the boiling point of a solvent being used. This is because, when the solvent removal temperature is the boiling point of the solvent or higher, the surface of the coated film is roughened due to volatilization of the solvent, and it is difficult to obtain a uniform coated film.

(Thermal Treatment Process)

In the invention, the film obtained by removing the solvent is heated to a temperature that is the liquid crystal transition temperature of the liquid crystal polyester which is a raw material or higher, and subjected to a thermal treatment at a temperature that is the liquid crystal transition temperature of the liquid crystal polyester which is a raw material or higher. For the thermal treatment, the temperature is preferably increased from a temperature of 0° C. to 220° C. Thereby, in the obtained insulating layer in the laminated base material or the liquid crystal polyester film according to the invention, the liquid crystal polyester shows a liquid crystal phase, and forms a domain oriented in the thickness direction. Liquid crystal polyester having such a domain formed therein has a high heat conductivity compared to liquid crystal polyester having no domain formed therein (in an amorphous state), and it is possible to obtain the insulating layer in the laminated base material or the liquid crystal polyester film according to the invention that is excellent in terms of heat conductivity in the thickness direction.

Here, the “liquid crystal transition temperature” is also called as a liquid crystallization temperature. The temperature is a temperature at which a schlieren pattern can be observed under a polarizing microscope with crossed-Nicol when melting the liquid crystal polyester while rising a temperature at a rate of 10° C./minute. The temperature can be measured as follows: a liquid crystalline polyester is placed on a heating stage of the polarizing microscope, and the liquid crystalline polyester is melted while rising a temperature at a rate of 10° C./minute, and then the temperature at which a schlieren pattern can be observed under a polarizing microscope with crossed-Nicol can be determined as a liquid crystal transition temperature. In addition, in the case where the liquid crystalline polyester was not completely melted under static condition, the liquid crystalline polyester could be completely melted under pressurized condition using spring pressure.

The rate of temperature increase for the thermal treatment carried out from a temperature of 0° C. to 220° C. to a temperature that is the liquid crystal transition temperature of the liquid crystal polyester or higher is preferably 1.0° C./min to 200° C./min, more preferably 3.0° C./min to 180° C./min, and still more preferably 8.0° C./min to 150° C./min. As the rate of temperature increase increases, there is a tendency of the heat conductivity of the thermally treated film in the thickness direction improving.

When the temperature rise time is long, there is a case in which the molecular weight of the liquid crystal polyester increases during the temperature rise, and the liquid crystal transition temperature of the liquid crystal polyester increases during the temperature rise. Then, there is a case in which the achieved temperature after a set temperature rise (the set thermal treatment temperature) becomes lower than the liquid crystal transition temperature of the liquid crystal polyester. Therefore, in a case in which the temperature rise begins at a low temperature, it is preferable to set a fast rate of temperature increase and shorten the temperature rise time. Thereby, it is possible to suppress a change in the liquid crystal transition temperature during the temperature rise and carry out a desired thermal treatment.

The temperature rise at the above rate is preferably carried out from a temperature of 0° C. to 220° C., and more preferably from a temperature of 40° C. to 150° C. In addition, the temperature rise at the above rate is preferably carried out up to a temperature of the liquid crystal transition temperature +10° C. or higher, and more preferably up to a temperature of the liquid crystal transition temperature +20° C. or higher.

The thermal treatment at the liquid crystal transition temperature or higher is preferably carried out at the temperature of “the liquid crystal transition temperature +10° C.” to the temperature of “the liquid crystal transition temperature +80° C.”, and more preferably at the temperature of “the liquid crystal transition temperature +20° C.” to the temperature of “the liquid crystal transition temperature +60° C.”. In addition, the thermal treatment time at the liquid crystal transition temperature or higher is preferably 0.5 hours to 10 hours, and more preferably 2 hours to 4 hours.

The thickness of the liquid crystal polyester obtained in the above manner is preferably 500 μm or less, and more preferably 200 μm or less in terms of heat conductivity in the thickness direction or flexibility. In addition, since the liquid crystal polyester becomes brittle when the thickness is too thin, the thickness is preferably 10 μm or more.

That is, the thickness of the insulating layer of the laminated base material or the liquid crystal polyester film according to the invention is preferably 10 μm to 500 μm, and more preferably 30 μm to 200 μm.

When a conductive foil, such as a metallic foil, is used as the supporting base material, a target laminated base material can be manufactured without separation of the supporting base material and the film.

Furthermore, a conductive layer other than the conductive foil may be formed on the laminated base material, and the conductive layer may be formed by laminating a metallic foil on a insulating layer through adhesion using an adhesive, fusion using thermal pressing, or the like, or by coating metallic particles on a insulating layer using a plating method, a screen printing method, a sputtering method, or the like. Examples of the metal composing the metallic foil or the metallic particles include copper, aluminum, and silver, and copper is preferably used in terms of conductivity or cost.

The laminated base material obtained in the above manner can be preferably used as a printed-wiring board for which the liquid crystal polyester film is used as the insulating layer by forming a predetermined wiring pattern on the conductive foil, and laminating a plurality of sheets as necessary.

(Filming Process)

In addition, a target liquid crystal polyester film can be manufactured by removing the conductive foil from the laminated base material or separating the insulting layer from the laminated base material. The supporting base material and the liquid crystal polyester film may be separated after the thermal treatment process or before the thermal treatment after removal of the solvent (that is, after the drying process and before the thermal treatment process).

According to the above method, it is possible to provide a method of manufacturing a laminated base material having a high heat conductivity. In addition, it is possible to provide a method of manufacturing a liquid crystal polyester film having a high heat conductivity.

Meanwhile, the above example is simply an example, and the invention can be modified in various manners based on design requirements and the like within the scope of the purports of the invention.

### EXAMPLES

Hereinafter, the invention will be described using examples, but the invention is not limited to the examples.

(Measurement of the Flow Initiation Temperature of the Liquid Crystal Polyester)

The flow initiation temperature of the liquid crystal polyester was measured using a flow tester (manufactured by Shimadzu Corporation, CFT-500). The liquid crystal polyester (approximately 2 g) was filled in a cylinder equipped with a die having a nozzle with an internal diameter of 1 mm and a length of 10 mm, the liquid crystal polyester was melted and extracted through the nozzle while increasing the temperature at a rate of 4° C./min under a load of 9.8 MPa (100 kg/cm²), and a temperature at which the viscosity reached 4800 Pa·s (48000 poise) was measured as the flow initiation temperature.

(Liquid Crystal Transition Temperature)

The liquid crystal transition temperature was obtained by placing resin powder on a heating stage (microscope cooling and heating stage 10002, manufactured by Linkam Scientific Instruments Ltd.) attached to a polarizing microscope (ECLIPSE LV100POL, manufactured by Nikon Corporation), and measuring the temperature of the resin at which the resin was melted so that a liquid crystal layer-specific Schlieren shape appeared when the resin powder was heated at 10° C./min under a direct nicol. Meanwhile, in a case in which the resin powder was not completely melted in a stationary manner, the liquid crystal transition temperature was obtained by sandwiching the resin powder using a pair of glass slides, and fixing the glass slides that sandwiched the resin using springs for sample fixing which were provided in the heating stage so as to apply a spring force to the resin, and, similarly, measuring the resin temperature at which the Schlieren shape appeared under pressurization.

### Manufacturing Example 1

### Manufacturing of Liquid Crystal Polyester (1)

6-Hydroxy-2-naphthoic acid (2823 g, 15.0 mol), 4-hydroxyacetanilide (1134 g, 7.5 mol), isophthalic acid (1246 g, 7.5 mol), and acetic anhydride (2603 g, 25.8 mol) were fed into a reactor vessel having a stirring apparatus, a torque meter, a nitrogen gas introduction pipe, a thermometer, and a reflux condenser, the gas in the reactor vessel was substituted by nitrogen gas, then, the temperature was increased from room temperature to 150° C. over 15 minutes while stirring the solution under a nitrogen gas stream, and the solution was refluxed at 150° C. over 3 hours. Next, the temperature was increased from 150° C. to 300° C. over 2 hours 50 minutes while distilling a byproduct of acetic acid and unreacted acetic anhydride away, and when the temperature reached 300° C., the contents were taken out from the reactor vessel and cooled to room temperature. The obtained solidified product was crushed using a crushing machine, thereby obtaining powder of liquid crystal polyester (1). The liquid crystal polyester (1) had a flow initiation temperature of 180° C. and a liquid crystal transition temperature of 240° C.

### Manufacturing Example 2

### Manufacturing of Liquid Crystal Polyester (2)

The liquid crystal polyester (1) obtained in the manufacturing example 1 was heated at 255° C. under a nitrogen gas atmosphere over 3 hours so as to be solid-phase polymerized, and then cooled, thereby obtaining powder of liquid crystal polyester (2). The liquid crystal polyester (2) had a flow initiation temperature of 300° C. and a liquid crystal transition temperature of 400° C.

### Example 1

The liquid crystal polyester powder obtained in the manufacturing example 1 (2200 g) was added to N-methylpyrrolidone (7800 g), heated at 100° C. for 2 hours so that it was confirmed that the liquid crystal polyester powder was completely dissolved so as to obtain a transparent solution, and then spherical α-alumina powder (SUMICORUNDUM AA-5, manufactured by Sumitomo Chemical Company, Limited.) having a volume average particle diameter of 5 μm exchanging from a density was added as a heat-conducting filling material.

Here, the amount of the heat-conducting filling material filled was set to 50% by volume with respect to the total amount of the liquid crystal polyester and the heat-conducting filling material. The obtained liquid-phase composition was stirred and defoamed, the obtained solution was coated on a copper foil so that the thickness became 80 μm after removal of the solvent, and then dried at 150° C. for 0.5 hours. Subsequently, the liquid-phase composition was heated from 40° C. to 300° C. at a rate of temperature increase of 9.0° C./min under a nitrogen stream, and a thermal treatment was carried out for 3 hours. The copper foil was etched from an obtained copper foil-attached film, and a liquid crystal polyester film of Example 1 was obtained.

### Comparative Example 1

A liquid crystal polyester film of Comparative example 1 was obtained in the same manner as for Example 1 except that the liquid crystal polyester powder obtained in the manufacturing example 2 (800 g) and N-methylpyrrolidone (9200 g) were used, and the drying conditions (temperature and time) during solvent removal was 150° C. and 1 hour.

### Comparative Example 2

A liquid crystal polyester film of Comparative example 2 was obtained in the same manner as for Example 1 except that the drying temperature during solvent removal was 100° C.

(Heat Conductivity)

The heat conductivities of the liquid crystal polyester films (Example 1 and Comparative examples 1 and 2) obtained in the above manner were computed from measurement of thermal diffusivity, isobaric specific heat capacity, and density using the following formula.

Conductivity (W/(m·K))=thermal diffusivity (m²/s)×specific heat (J/(kg·K))×density (kg/m³)

The thermal diffusivity was measured in a sample thickness direction at room temperature using a sample having a 10 mm×10 mm×0.1 mm size through a temperature wave analysis (ai-Phase Mobile, manufactured by ai-Phase Co., Ltd.).

(Specific Heat)

The specific heat was measured from comparison with a sapphire standard substance using a differential scanning calorimeter (DSC) (manufactured by PerkinElmer Corporation, DSC 7) as an apparatus.

(Density)

The density was measured using an Archimedes method.

The results of Example 1 and Comparative examples 1 and 2 are shown in Table 1.

TABLE 1

| | | Comparative | Comparative |
|---|---|---|---|
| | Example 1 | example 1 | example 2 |
| Liquid crystal transition | 240° C. | 400° C. | 240° C. |
| temperature (° C.) | | | |
| Drying temperature (° C.) | 150° C. | 150° C. | 100° C. |
| Thermal diffusivity | 26.2 | 7.40 | 21.5 |
| (×10⁻⁷ m²/s) | | | |
| Specific heat (×10³ J/(kg · K)) | 1.0 | 1.0 | 1.0 |
| Density (kg/m²) | 2.60 | 2.62 | 2.48 |
| Heat conductivity (W/(m · k)) | 6.8 | 1.94 | 5.3 |

As a result of the measurements, in Example 1, a high heat conductivity was obtained compared to the samples of Comparative examples.

On the other hand, in Comparative example 1, since the liquid-phase composition was not heated to the liquid crystal transition temperature or higher during the thermal treatment, the heat conductivity was low.

In addition, in Comparative example 2, since the drying temperature during solvent removal was lower than 120° C., a number of pores remained, and the specific weight lowered. Therefore, the heat conductivity became low while the same material as for Example 1 was used.

From the results, the usefulness of the invention was confirmed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A method of manufacturing a laminated base material having a conductive foil and an insulating layer formed on the conductive foil, comprising:
a drying process in which a liquid composition which includes a liquid crystal polyester, a solvent in which the liquid crystal polyester dissolves, and a heat-conducting filling material, and has a proportion of the content of the heat-conducting filling material in the sum of the content of the liquid crystal polyester and the content of the heat-conducting filling material of 30% by volume to 80% by volume is coated on the conductive foil, heated to 120° C. to 220° C. so as to remove the solvent, thereby forming a coated film; and
a thermal treatment process in which the coated film formed on the conductive foil is heated to a temperature that is the liquid crystal transition temperature of the liquid crystal polyester or higher so as to form an insulating layer.

2. The method of manufacturing a laminated base material according to claim 1,
wherein, in the thermal treatment process, the insulating layer is formed by increasing the temperature of the coated film at a rate of 1.0° C./min to 200° C./min from a temperature of 0° C. to 220° C. to a temperature that is the liquid crystal transition temperature of the liquid crystal polyester or higher.

3. The method of manufacturing a laminated base material according to claim 1,
wherein the heat-conducting filling material includes at least one inorganic powder selected from a group consisting of aluminum oxide, aluminum nitride, and boron nitride.

4. The method of manufacturing a laminated base material according to claim 1,
wherein the liquid crystal polyester is a liquid crystal polyester having a repeating unit represented by the following formula (1), a repeating unit represented by the following formula (2), and a repeating unit represented by the following formula (3),
—O—Ar¹—CO— (1)
—CO—Ar²—CO— (2)
—X—Ar³—Y— (3)
wherein, Ar¹ represents a phenylene group, a naphthylene group, or a biphenylylene group; each of Ar² and Ar³ represent a phenylene group, a naphthylene group, a biphenylylene group, or a group represented by the following formula (4); each of X and Y independently represent an oxygen atom or an imino group; each of hydrogen atoms in the groups represented by Ar¹, Ar², and Ar³ may be replaced by a halogen atom, an alkyl group, or an aryl group;
—Ar⁴—Z—Ar⁵— (4)
wherein, each of Ar⁴ and Ar⁵ independently represent a phenylene group or a naphthylene group; and Z represents an oxygen atom, a sulfur atom, a carbonyl group, a sulfonyl group, or an alkylidene group.

5. The method of manufacturing a laminated base material according to claim 4,
wherein the liquid crystal polyester has 30 mol % to 80 mol % of the repeating unit represented by the formula (1), 10 mol % to 35 mol % of the repeating unit represented by the formula (2), and 10 mol % to 35 mol % of the repeating unit represented by the formula (3) with respect to the total amount of all the repeating units that compose the liquid crystal polyester.

6. The method of manufacturing a laminated base material according to claim 4,
wherein, in the repeating unit represented by the formula (3), at least one of X and Y is an imino group.

7. A method of manufacturing a liquid crystal polyester film comprising:
a drying process in which a liquid composition which includes the liquid crystal polyester, a solvent in which the liquid crystal polyester dissolves, and a heat-conducting filling material, and has a proportion of the content of the heat-conducting filling material in the sum of the content of the liquid crystal polyester and the content of the heat-conducting filling material of 30% by volume to 80% by volume is coated on a supporting base material, heated to 120° C. to 220° C. so as to remove the solvent, thereby forming a coated film;
a thermal treatment process in which the coated film formed on the supporting base material is heated to a temperature that is the liquid crystal transition temperature of the liquid crystal polyester or higher; and
a filming process in which the supporting base material is removed so as to obtain a liquid crystal polyester film.

8. The method of manufacturing a laminated base material according to claim 2,
wherein the heat-conducting filling material includes at least one inorganic powder selected from a group consisting of aluminum oxide, aluminum nitride, and boron nitride.

9. The method of manufacturing a laminated base material according to claim 5,
wherein, in the repeating unit represented by the formula (3), at least one of X and Y is an imino group.
